(19) United States
(12) Patent Application Publication
(10) Pub. No.: US 2012/0166696 A1
(43) Pub. Date: Jun. 28, 2012

(54) Method, Apparatus and Computer Program Code Handling a User Input

(75) Inventors: Janne Jouni Kallio, Pattijoki (FI); Kari Matias Severinkangas, Oulu (FI); Ari Veijo Pentti Helaakoski, Oulu (FI); Pertti Juhani Saarinen, Koniginkangas (FI)

(73) Assignee: NOKIA CORPORATION, Espoo (FI)

(21) Appl. No.: 13/378,343

(22) PCT Filed: Jun. 26, 2009
(86) PCT No.: PCT/EP2009/058063

§ 371 Date: Mar. 14, 2012

(51) Int. Cl. G06F 13/24

(52) U.S. Cl. 710/260

(57) ABSTRACT

For handling a user input, an indication of a current state is received from a processor. When a user input is detected, it is determined whether the user input matches a criterion that is defined for the current state. An interrupt request to the processor is generated if it is determined that the user input matches the criterion defined for the current state.

### FIELD OF THE DISCLOSURE

The invention relates to the field of user interfaces, and more specifically to the handling of a user input to an electronic device.

### BACKGROUND

Many electronic devices enable a user to control the device by means of a user input. A user input can be carried out for instance via a keypad, a touch screen or a microphone, or by moving the device in a manner that is detected by a motion sensor.

Various electronic devices may enter a state in which only a certain user input is associated to a selectable function.

Some electronic devices enable a user for instance to lock the device so that the device may only be used again after a secret code has been entered or when an emergency call number is entered.

Some electronic devices having a keypad enable a user to set a key guard state. Such a key guard state may also be entered automatically by the electronic device when no user input has been detected for a predetermined period of time. A predetermined user input will unlock the keys again. Otherwise, only entering an emergency call number will open the key guard. This avoids the activation of undesired operations when a key is pressed accidentally, for instance when the device is kept in a pocket, a handbag or the like.

When a key guard or a device lock is active and a user presses any key, a keypad controller typically sends an interrupt request to a main processor to check whether the pressing of the key is an allowed user input in the current state. The interrupt request wakes up the processor and subsystems like clocking. The processor wakes up a display to provide a notification to the user about the necessity to open the key guard or device lock and to guide the user to enter the right key pattern to open the key guard or the device lock. Also the backlight may be activated for a short period. The main processor software driver then reads information indicating which keys have been pressed, for instance key dome matrix information, and sends a corresponding key event to upper layers like applications and middleware, where a key pattern detection is carried out. Any further operation depends on this evaluation.

### SUMMARY OF SOME EMBODIMENTS OF THE INVENTION

A method is described, which comprises receiving an indication of a current state from a processor. The method further comprises detecting a user input and determining whether the user input matches a criterion that is defined for the current state. The method further comprises generating an interrupt request to the processor if it is determined that the user input matches the criterion defined for the current state.

Moreover, a first apparatus is described, which comprises means for receiving an indication of a current state from a processor and means for detecting a user input. The apparatus further comprises means for determining whether the user input matches a criterion that is defined for the current state. The apparatus further comprises means for generating an interrupt request to the processor if it is determined that the user input matches the criterion defined for the current state.

The means of this apparatus can be implemented in hardware and/or software. They may comprise for instance a processor for executing computer program code for realizing the required functions, a memory storing the program code, or both. Alternatively, they could comprise for instance a circuit that is designed to realize the required functions, for instance implemented in a chipset or a chip, like an integrated circuit.

Moreover, a second apparatus is described, which comprises at least one processor and at least one memory including computer program code, the at least one memory and the computer program code configured to cause the processor at least to perform the following: receiving an indication of a current state from another processor; detecting a user input; determining whether the user input matches a criterion that is defined for the current state; and generating an interrupt request to the other processor if it is determined that the user input matches the criterion defined for the current state.

Moreover, a computer readable storage medium is described, in which computer program code is stored. The computer program code causes a processor to realize the following when executed by this processor: receiving an indication of a current state from another processor, detecting a user input, determining whether the user input matches a criterion that is defined for the current state, and generating an interrupt request to the other processor if it is determined that the user input matches the criterion defined for the current state.

The computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood that also the computer program code by itself has to be considered an embodiment of the invention.

Thus, certain embodiments of the invention provide that a processor, which is generally informed about a user input via an interrupt, is not interrupted upon any user input in any state. At least for certain states, a condition is defined that has to be fulfilled by the user input before an interrupt is caused. This may have the advantage that the processor does not have to be involved e.g. in the case of accidentally pressed keys. Such a filtering of user input may reduce the load on the processor so that more processing power is available for other tasks. Furthermore, such a filtering of user input may result in significant power savings, since the processor and associated components have to be woken up less frequently during sleep cycles. For instance, if the processor is a host processor of a device that is responsible for the main processing in the device and that has to take into account a large number of hardware and software dependencies, the preprocessing can be performed with less energy required by a small component with limited functionality and dependencies. Power savings, in turn, may result in an increase of the standby time of devices that rely on a battery for the power supply.

In one embodiment of the described method, the method further comprises receiving from the processor for at least one state in addition information about at least one criterion defined for the at least one state. In a corresponding embodiment of one of the described apparatuses the program code and the processor, which are provided for determining whether the user input matches a criterion that is defined for the current state, or some other means are configured to realize a corresponding function. In a corresponding embodiment of the described computer program code and the described computer readable storage medium, the code may be defined to cause a corresponding action when executed.

The information about at least one criterion defined for the at least one state may be received once during an initialization phase or each time the associated state is indicated to be the new current state. With the first approach, less information has to be transferred, while with the second approach less memory has to be available at the entity performing the preprocessing for storing the criteria. Receiving the criteria from the processor ensures that the component performing the preprocessing can be employed in a particularly flexible manner for different and adaptive criteria and states. It is to be understood, however, that in other embodiments the criteria may already be implemented in a fixed manner in the component performing the preprocessing during the production of the component.

The criterion may comprise any requirement on a user input that has to be met in a certain state for causing the generation of an interrupt request. In one embodiment, it comprises for example at least one of: an activation of a predetermined key, an activation of a predetermined key at least for a predetermined time, e.g. more than 50 ms, an activation of a predetermined combination of keys, and an activation of a predetermined combination of keys within a predetermined time span. A combination of keys may involve two or more keys. A combination of keys may further be required to be activated in sequence or simultaneously. In addition or alternatively, the condition may relate to other kinds of user input, like a stroke or a combination of strokes on a touch sensitive user interface. The criterion may also comprise the application of a predetermined force, which may be detected via a force sensor, possibly combined with an input via a predetermined capacitive touch button. The criterion may also comprise a predetermined combination of touch buttons being pressed, for instance touch buttons located in different areas of a device. A certain combination of touch buttons could be suited for instance to indicate a situation when the device is held in a hand of a user, for example as an indication that the user wants to operate the device. Also various other kinds of user input can be considered.

A predetermined key, key stroke or touch button could be for instance the first digit of a code for unlocking a device in a device lock state or the first digit of an emergency number in a device lock state. A predetermined combination of keys, key strokes or touch buttons could be for instance a sequence of keys required for turning off a keylock state. Such a sequence could be for example the combination ‘left soft key’ or ‘menu key’ followed by the ‘*’ key, or the combination ‘main soft key’ followed by ‘left soft key’, or whichever other combination is defined for unlocking the keypad.

It is to be understood that for a certain state, several criteria may be defined. An interrupt request could then be generated in case at least one of these criteria is met by a user input.

In addition to the indication of the current state and, optionally, the condition for a respective state, the processor could provide various additional information, for instance rules on how to proceed in case the criterion is not met or met only partially. The described method, computer program code and apparatuses could also be responsible for additional low level tasks based on such rules.

In one embodiment of the described method, the method further comprises causing a feedback to a user. Causing the feedback may be independent from a participation of the processor from which the indication of the current state is received. Thus, this processor and associated components do not need to wake up for the feedback. In an example embodiment, the processor may have at some times higher rated tasks than feedback on schedule, which may cause delay variations in the feedback, especially when the load of the processor is high. As a result, a user may experience different delays for a feedback to the same user input, when the feedback is handled by the processor. Enabling a feedback without involvement of such a processor, as suggested, may thus have the effect that the feedback delay can be kept constant and improve the user experience. In a corresponding embodiment of one of the described apparatuses the program code and the processor, which are provided for determining whether the user input matches a criterion that is defined for the current state, or some other means are configured to realize a corresponding function. In a corresponding embodiment of the described computer program code and the described computer readable storage medium, the code may be defined to cause a corresponding action when executed.

In one embodiment of the described method, causing such a feedback comprises causing a notification of a user if it is determined that the user input does not match at least one criterion defined for the current state. The notification may inform a user for instance which user input would match the criterion in the current state. In a corresponding embodiment of one of the described apparatuses the program code and the processor, which are provided for determining whether the user input matches a criterion that is defined for the current state, or some other means are configured to realize a corresponding function. In a corresponding embodiment of the described computer program code and the described computer readable storage medium, the code may be defined to cause a corresponding action when executed.

In one embodiment of the described method, causing the feedback comprises causing an indication to a user, which further user input has to be carried out to ensure that the user input matches the entire criterion, if it is determined that the user input matches a part of a criterion defined for the current state. In a corresponding embodiment of one of the described apparatuses, the program code and the processor, which are provided for determining whether the user input matches a criterion that is defined for the current state, or some other means are configured to realize a corresponding function. In a corresponding embodiment of the described computer program code and the described computer readable storage medium, the code may be defined to cause a corresponding action when executed.

In one embodiment of the described method, the method further comprises coordinating feedback to a user which is caused by the processor from which the indication of the current state is received and feedback to a user which is caused independently from a participation of the processor from which the indication of the current state is received. Such a coordination may be implemented in case a single actuator may be addressed at the same time by different entities to avoid any conflict. The coordination may be based for example on a prioritization policy and/or on a mixing policy. In a corresponding embodiment of one of the described apparatuses, the program code and the processor, which are provided for determining whether the user input matches a criterion that is defined for the current state, or some other means are configured to realize a corresponding function. In a corresponding embodiment of the described computer program code and the described computer readable storage medium, the code may be defined to cause a corresponding action when executed.

In general, the feedback to a user may be of any suitable kind, for instance visible, audible or haptic. A visual feedback could comprise for instance corresponding information on a display, or an illumination of a key that should be pressed next, or a light guide to indicate the right keys to be pressed, etc. For a visible feedback, also a decorative display could be employed. A haptic feedback could be provided by a tactile feedback actuator. For a haptic feedback, a user could feel for example a button on a haptic feedback area, before a user puts more force on it and makes a real pressing.

The presented direct feedback may be used for instance as a feedback to the activation of simulated statics keys, either of a virtual keyboard or of touch keys outside of the display area, but it could also be used as a feedback for various other kinds of user input, including a touch sensitive full screen area.

In one embodiment, the current state is one of a plurality of predetermined states including at least one locked state. Such a locked state could be for instance a key guard state or a device lock state. Other possible states may comprise a normal state, a charging state, a location tracking state, etc.

Any of the described apparatuses may comprise only the indicated components or one or more additional components. Possible additional components comprise components enabling a user input, like a keypad, a touch sensitive user interface and a three-dimensional motion sensor, e.g. in the form of an accelerometer. Possible additional components comprise components providing measurement results, like a satellite based navigation system receiver, an ambient light sensor or a force sensor. Possible additional components comprise components enabling a feedback to a user, like a lighting circuitry, an adaptive decoration and a haptic feedback component. A lighting circuitry may comprise for instance a backlight for a display or light-emitting-diodes (LEDs) associated to each key of a keypad.

In one embodiment, the described apparatuses comprise in addition the processor, from which the indication of a current state is received, and at least one associated memory including computer program code. The at least one memory and the computer program code are configured to cause the processor at least to generate and provide the indication of a current state upon a respective change of state.

Any of the described apparatuses may be a module or component for a user device, for example a chip, a keyboard controller or an illumination controller. Alternatively, any of the described apparatuses may be a user device, like a mobile communication device.

In one embodiment, the described method is an information providing method, and the described first apparatus is an information providing apparatus. In one embodiment, the means of the described first apparatus are processing means.

In certain embodiments of the described methods, the methods are methods for handling a user input or methods for preprocessing a user input. In certain embodiments of the described apparatuses, the apparatuses are apparatuses for handling a user input or apparatuses for preprocessing a user input.

It is to be understood that any feature presented for a particular exemplary embodiment may also be used in combination with any other described exemplary embodiment of any category.

Further, it is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an exemplary embodiment of an apparatus according to the invention;

FIG. 2 is a flow chart illustrating an exemplary operation in the apparatus of FIG. 1;

FIG. 3 is a schematic block diagram of a further exemplary embodiment of an apparatus according to the invention;

FIG. 4 is a flow chart illustrating an exemplary operation in the apparatus of FIG. 3;

FIG. 5 is a flow chart illustrating a further exemplary operation in the apparatus of FIG. 3;

FIG. 6 is a flow chart illustrating a further exemplary operation in the apparatus of FIG. 3;

FIG. 7 is a schematic block diagram showing elements of a further exemplary embodiment of an apparatus according to the invention:

FIG. 8 is a schematic block diagram presenting a further exemplary embodiment of an apparatus according to the invention; and

FIG. 9 is a schematic diagram illustrating different feedback options in an exemplary embodiment of the invention.

### DETAILED DESCRIPTION OF THE FIGURES

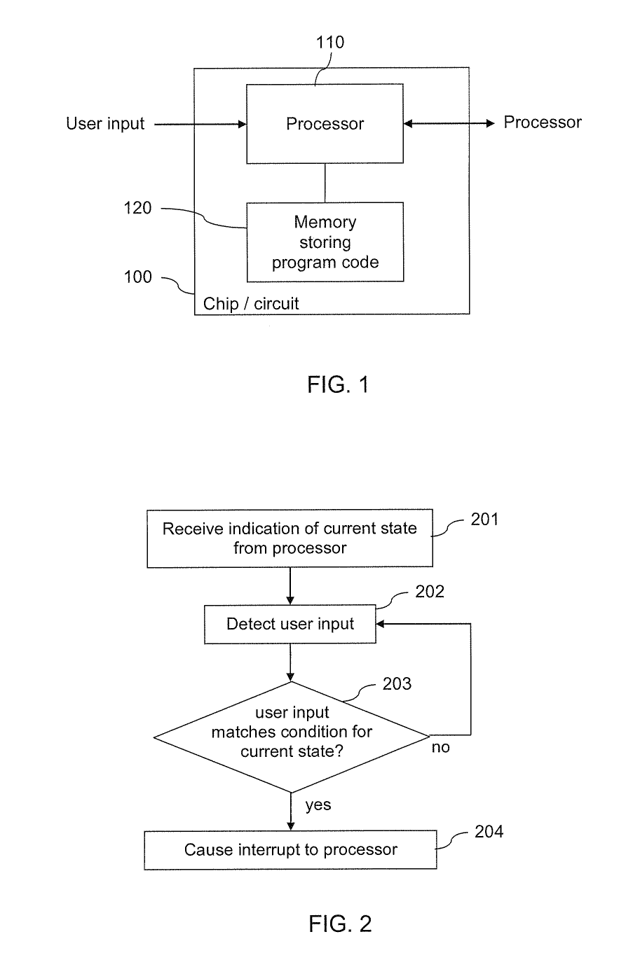

FIG. 1 is a schematic block diagram of an exemplary embodiment of an apparatus according to the invention.

In this embodiment, the apparatus is a chip 100 or a circuit on a chip. The chip 10 comprises a processor 110 and a memory 120. The memory 120 stores computer program code for pre-processing a user input. In addition, the memory 120 may store computer program code implemented to realize other functions, as well as information that is needed for the pre-processing and/or other information. The processor 110 is configured to execute computer program code stored in the memory 120. The chip 100 belongs to a device that comprises in addition one or more components enabling a user input and another processor. Processor 110 comprises interfaces configured to receive information about a user input and to communicate with the other processor.

An operation of the apparatus 100 will now be described with reference to the flow chart of FIG. 2. The operation is an exemplary embodiment of a method according to the invention. The program code for pre-processing a user input causes processor 110 to perform the operations when the program code is retrieved from memory 120 and executed by processor 110.

The processor 110 receives an indication of a current state from the other processor (action 201). Such an indication may be received for instance whenever the state changes or whenever a particular predetermined state is entered.

When a user performs an input, this is detected by processor 110 (action 202). Processor 110 determines thereupon whether the user input matches a condition that has been defined for the current state (action 203).

If the user input matches such a condition, processor 110 generates an interrupt request to the other processor (action 204). Otherwise, processor 110 waits for a further user input (action 202), until the user input matches the defined condition (action 203).

The described embodiment may have the advantage that it enables a power saving at the other processor, since the other processor is not interrupted when a user input is performed by mistake in a current state, in which no function is mapped to the performed kind of user input. If processor 110 is designed in a low power architecture that is only responsible for a very limited number of functions, and thus designed to use less power than the other processor, also the total power consumption is reduced.

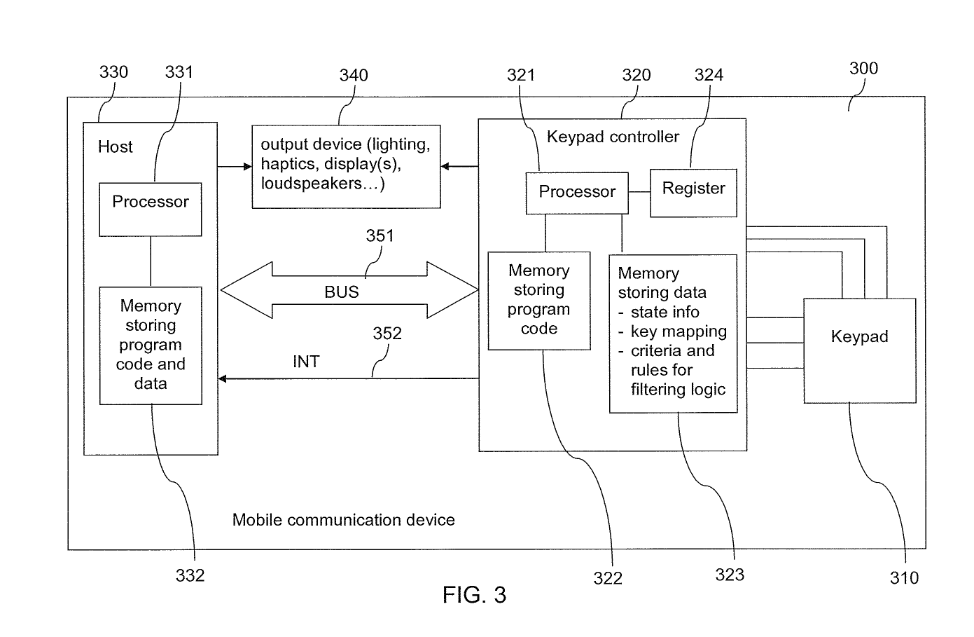

Exemplary implementation details for the described features and actions as well as exemplary additional features and actions will become apparent from the description of FIGS. 3 to 7. Any of the features described in the following may be integrated in the embodiment of FIG. 1 by itself or in combination with any other of the described features.

FIG. 3 is a schematic block diagram of another exemplary embodiment of an apparatus according to the invention.

In this embodiment, the apparatus is a mobile communication device 300, for instance a mobile phone.

The mobile communication device 300 comprises inter alia a keypad 310, a keypad controller 320, a host 330 and an output device 340.

Keypad 310 may comprise a key matrix. Each key of the keypad is associated to a combination of a column and a row of the matrix.

Keypad controller 320 comprises a processor 321, a memory 322 storing computer program code, a memory 323 storing data and a register 324. When processor 321 executes program code retrieved from memory 322, the program code causes processor 321 to perform the functions of keypad controller 320. Keypad controller 320 is for instance configured to detect when a key is pressed, for example by scanning columns and rows of the key matrix. An indication of the latest pressed keys may be stored in register 324. Memory 323 stores data that is required by the executed program code. Memory 322 and memory 323 may also be comprised in a single memory module.

Host 330 comprises a processor 331 and a memory 332 storing computer program code and data. Memory 332 may comprise more than one memory module. For example, computer program code and data may be stored in separate memory modules. When processor 331 executes program code retrieved from memory 332, the program code causes processor 331 to perform the functions of host 330.

Keypad controller 320 and host 330 are linked to each other by a bus 351 and by an interrupt line 352. Keypad controller 320 and host 330 may also be linked by more than one interrupt line. Alternatively, interrupt line 352 may be part of bus 351. Further, an interrupt may be generated by bus activity of bus 351, thus no separate interrupt line may be needed. Interrupt line 352 can be used by keypad controller 330 to send an interrupt request to host 330. Bus 351 can be for example an Inter-Integrated Circuit (I²C) bus, a Serial Peripheral Interface (SPI) bus, a Serial Low-power Inter-chip Media Bus (SLIMBUS) or any other kind of serial or parallel bus. It can be used by host 330 for instance to send control data to keypad controller 320, or to read the content of register 324 of keypad controller 320 upon an interrupt request.

Keypad controller 320 and host 330 could be arranged for example on separate chips or on a common chip.

The output device 340 can be controller by host 330 and/or by keypad controller 320 via a respective interface. The output device 340 may comprise for example LEDs illuminating keys of the keypad, an adaptive decoration, a tactile feedback actuator, a main display of mobile communication device 300, a secondary display of mobile communication device 300, a backlight for a display, and/or loudspeakers, etc.

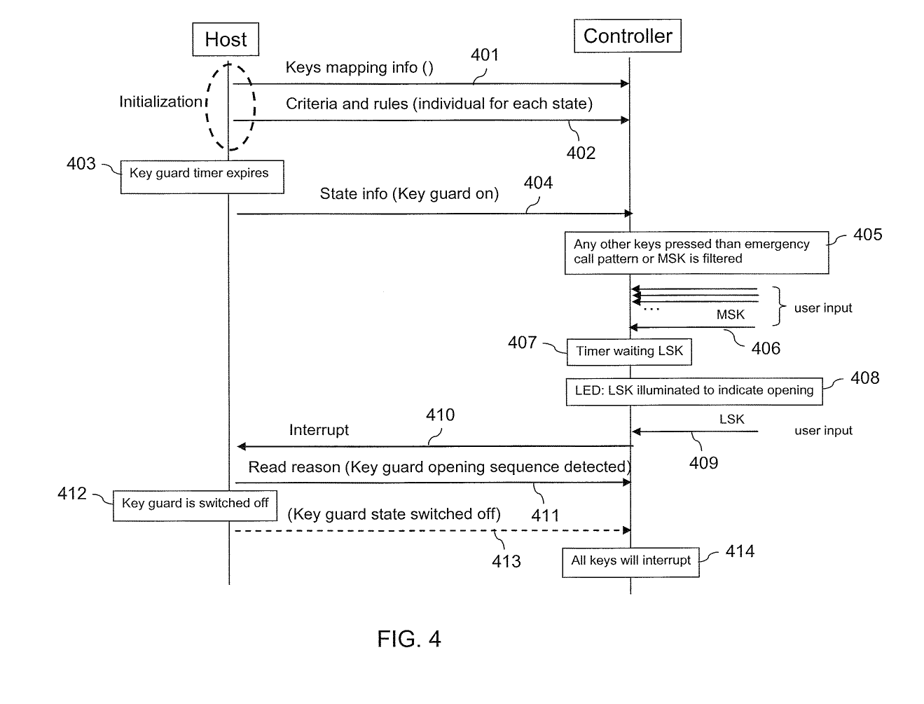

An exemplary operation of the apparatus in a key guard state will now be described in more detail with reference to the flow chart of FIG. 4. A vertical line on the left hand side represents host 330, while a vertical line on the right hand side represents keypad controller 320. Blocks represent actions at a respective one of these entities 320, 330, while arrows between both lines represent a communication between both entities 320, 330. The operations of host 330 can be considered to be performed by processor 331 when executing the program code from memory 332. The operations of keypad controller 320 can be considered to be performed by processor 321 when executing the program code for pre-processing a user input retrieved from memory 322. The operation of the keypad controller 320 is an exemplary embodiment of a method according to the invention.

During an initialization phase, host 330 sends various kinds of information to keypad controller 320, which is stored at keypad controller 320 in memory 323.

The information may include for instance key mapping information (action 401). The key mapping information is an indication which meaning actually corresponds to each key of keypad 310. If this information is transferred to keypad controller 320 instead of being stored in a fixed manner in keypad controller 320, the same keypad controller 320 can be used for different keypads.

The information that is transferred from host 330 to keypad controller 320, for example during the initialization phase, may include in addition criteria and rules for a filtering logic for different possible states (action 402). The states may include a key guard state, a device lock state, a normal state, a charging state, etc. A criterion defines a user input that shall cause keypad controller 320 to generate an interrupt request to host 330 in a certain state. A rule defines which further actions keypad controller 320 should take under certain conditions in a certain state. A criterion that is valid for all states could include an emergency call pattern, like ‘112’ or ‘911’, or a first digit of such an emergency call pattern, that has to be activated by a user to start an emergency call. A further criterion for a key guard state could include for instance a key pattern that has to be activated by a user, possibly within an indicated time span, to open the key guard. In the present example, this is the sequence ‘middle soft key’ (MSK) and ‘left soft key’ (LSK). A further criterion for a device lock state could include for instance a key pattern or the first digit of a key pattern that has to be activated by a user to unlock the device 300.

Additional individual rules for both states could define a feedback to a user when wrong or correct keys are pressed.

When host 330 detects a change of state, it informs the keypad controller 320 accordingly. For example, when a key guard timer of host 330 expires (action 403), a key guard is switched on, and the state information ‘key guard state’ is provided via bus 351 to keypad controller 320 (action 404). Thereafter, host 330 may go to a sleep mode. Keypad controller 320 stores also the state information in memory 323.

It is to be understood that at least part of the information that is transmitted during the initialization phase (action 401, 402) could also be transmitted to keypad controller 320 each time information on a changed state is provided. Further, at least a part of the information that is transmitted during the initialization phase could also be stored in a fixed manner in memory 323 of keypad controller 320.

Once keypad controller 320 has received the state information that the key guard has been switched on, it selects from memory 323 criteria and rules of the filtering logic for the key guard state and starts filtering all subsequent key pressings.

More specifically, all other key pressings than the emergency call pattern or the MSK are discarded (action 405). That is, in these cases no action is performed. When a pressing of the MSK is detected (action 406), in contrast, a timer in keypad controller 320 is activated (action 407). In addition, an LED of output device 340 is activated by keypad controller 320, which illuminates the LSK to indicate to the user that this key has to be pressed in addition to switch off the key guard (action 408).

When the LSK is not pressed until the timer runs off, keypad controller 320 continues with action 405.

When the LSK is pressed before the timer runs off (action 409), keypad controller 320 generates an interrupt request and sends it via the interrupt line 352 to host 330 (action 410).

Host 330 is woken up by the interrupt request and reads thereupon via bus 351 the reason for the interrupt (action 411). It may read for instance the current content of register 324 and detect that the key guard opening sequence has been entered. Alternatively, it may be informed directly by processor 321 that the key guard opening sequence has been entered. In another embodiment, an interrupt in the state “key guard on” may only be interpreted as an opening sequence of the key guard. Thus, the reason for the interrupt may not be read through bus 351.

When learning that the key guard opening sequence has been entered, host 330 switches the key guard off (action 412).

Host 330 further informs keypad controller 320 via bus 351 that the key guard state has been switched off, or alternatively that a ‘normal state’ is now the current state (action 413).

Keypad controller 320 will thereupon generate an interrupt request to host 330 for any key that is pressed (action 414), until it is informed again about a change of state.

When host 330 learns after an interrupt request instead that an emergency call pattern has been entered, host 330 may open the key guard, switch on a backlight of a display, display the ‘911’ or ‘112’ on the screen and wait that the user presses the ‘green button’ to establish the desired connection.

A similar operation can be performed in various other states.

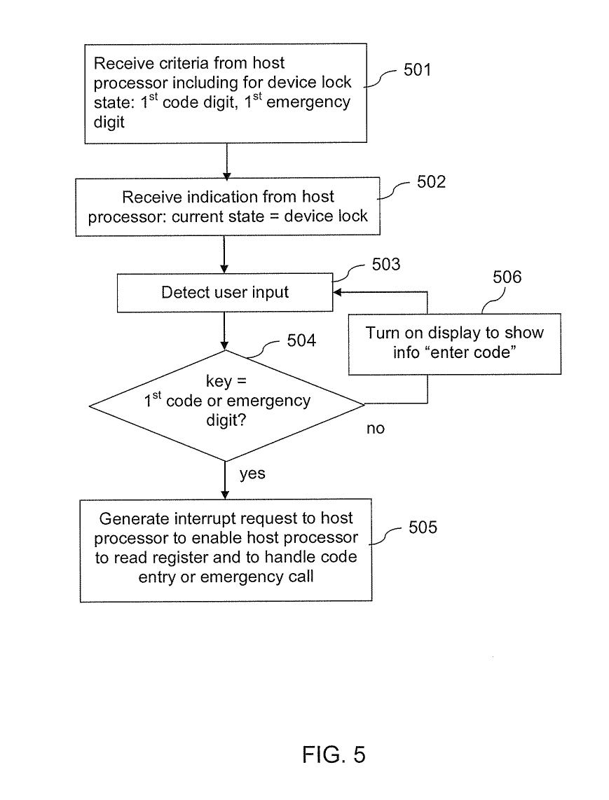

FIG. 5 is a flow chart which presents another exemplary operation of the apparatus of FIG. 3 in a device lock state. The depicted actions are performed at keypad controller 320. The operations of keypad controller 320 can be considered again to be performed by processor 321 when executing the program code for pre-processing a user input retrieved from memory 322. The operation of the keypad controller 320 is another exemplary embodiment of a method according to the invention.

Keypad controller 320 receives criteria and rules for different states from host 330 (action 501), for example during an initialization phase. For a device lock state, a first criterion includes the first digit of a code to unlock the device and a second criterion includes the first digit of an emergency call number. The information is stored in memory 323. Action 501 may thus belong to the same initialization phase as actions 401 and 402 of FIG. 4.

When host 330 detects in a conventional manner that the user locked the device 300, host 330 sends an indication to keypad controller 320 that the new current state is a device lock state. Keypad controller 320 receives this information (action 502) and stores an indication of the current state in memory 323.

When keypad controller 320 then detects a user input via keypad 310 (action 503), it determines the current state from memory 323 and applies a filtering logic using the criteria and rules associated to the current state in memory 323. It thus determines whether the pressed key corresponds to the stored 1^{st} digit of the code for unlocking the device or to the stored 1^{st} digit of an emergency number (action 504).

If this is the case, keypad controller 320 generates an interrupt request and sends it via interrupt line 352 to host 330 to enable host 330 to read register 324 of keypad controller 320 and to handle a code entry or an emergency call, respectively (action 505). The handling may include for instance presenting information to a user on a display 340 to support the final unlocking of the device 300 or the final establishment of an emergency call.

If keypad controller 320 determines in contrast that the pressed key corresponds neither to the stored 1^{st} digit of the code for unlocking the device nor to the stored 1^{st} digit of an emergency number (action 504), it requests the user via display 340 to enter the code to unlock the device (action 506). It is to be understood that keypad controller 320 could at first present exactly the same information on the display as host 330 for handling a code entry, and vice versa, to avoid that the first digit can be guessed by different reactions of keypad controller 320 and host 330 to a wrong and a correct digit respectively.

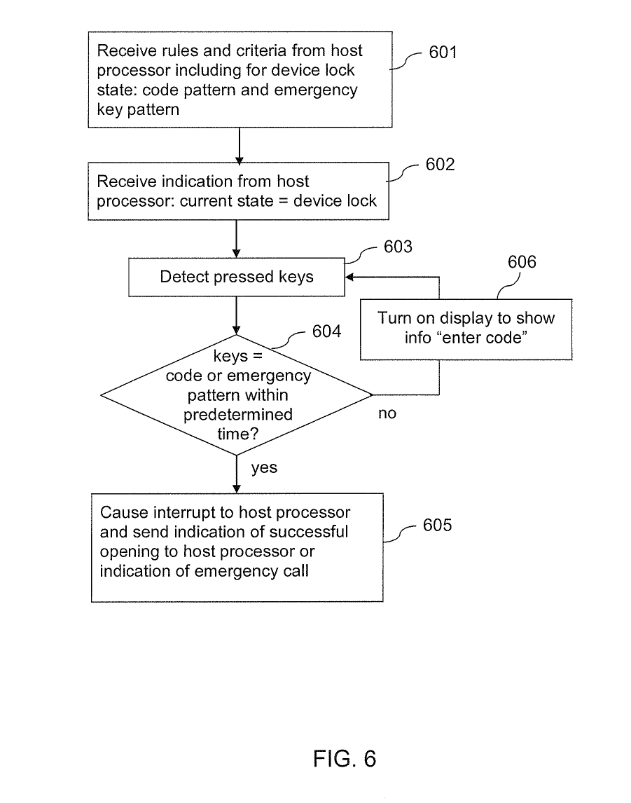

FIG. 6 is a flow chart which presents an exemplary variation of the operation presented in FIG. 5. The depicted actions are performed again at keypad controller 320. The operations of keypad controller 320 can be considered again to be performed by processor 321 when executing the program code for pre-processing a user input retrieved from memory 322. The presented operation of the keypad controller 320 is another exemplary embodiment of a method according to the invention.

During an initialization phase, keypad controller 320 receives criteria and rules for different states from host 330 (action 601). For a device lock state, a first criterion include as a first key pattern the entire code to unlock the device, and an indication of a time span within which the key pattern has to be entered. A second criterion includes as a second key pattern an entire emergency call number, and an indication of a time span within which the key pattern has to be entered. The information is stored in memory 323. Also action 601 may thus belong to the same initialization phase as actions 401 and 402 of FIG. 4.

It is to be understood that a high security is needed when transmitting the code pattern from host 330 to keypad controller 320. Encryption could be used as one solution to achieve this security.

When host 330 detects in a conventional manner that the user locked the device, host 330 sends an indication to keypad controller 320 that the new current state is a device lock state. Keypad controller 320 receives this information (action 602) and stores an indication of the current state in memory 323.

When keypad controller 320 then detects a user input via keypad 310 (action 603), it determines the current state from memory 323 and applies a filtering logic using the criteria and rules associated to the current state in memory 323. Keypad controller 320 thus determines whether a pressed sequence of keys corresponds to the stored key pattern for the code for unlocking the device 300 or for the stored emergency number, and whether the sequence has been entered within the predetermined time span (action 604).

If this is the case, keypad controller 320 generates an interrupt request and sends it to host 330 via interrupt line 352. In addition, it makes available information that a successful opening of the device has been carried out or that an emergency call is desired, respectively, via bus 351 (action 605). This enables host 330 to read the information from the bus 351 and to act accordingly, for instance by opening the device lock or by enabling a user to complete the establishment of an emergency call.

If keypad controller 320 determines in contrast that the pressed sequence of key corresponds neither to the stored 1^{st} digit of the code for unlocking the device nor to the stored 1^{st} digit of an emergency number or that the sequence has not been entered within the predetermined time span (action 604), keypad controller 320 turns on a low power secondary display 340 to request the user to enter the code to unlock the device (action 605). Then, keypad controller 320 waits whether a further sequence of keys is pressed to continue with actions 603 and 604.

FIGS. 2, 5 and 6 may also be understood to represent exemplary functional blocks of a computer program code for pre-processing a user input.

Keypad controller 320 of device 300 of FIG. 3 thus pre-processes pressed keys and interrupts host 330 only when really needed, that is, when the right key pattern corresponding to the current device state is occurring.

Similarly as in the embodiment of FIG. 1, a power saving and thus a longer stand-by time can be achieved. In addition, the embodiment of FIG. 3 may enable a faster feedback to the user, since the feedback latency does not depend anymore on the load of host processor 331.

It is to be understood that a similar logic could also be used for other states than a lock state, that is, in any case in which the device is in some specific state in which at least one key does not have a function. Further, it could be used for other kinds of user input than a user input via a keypad.

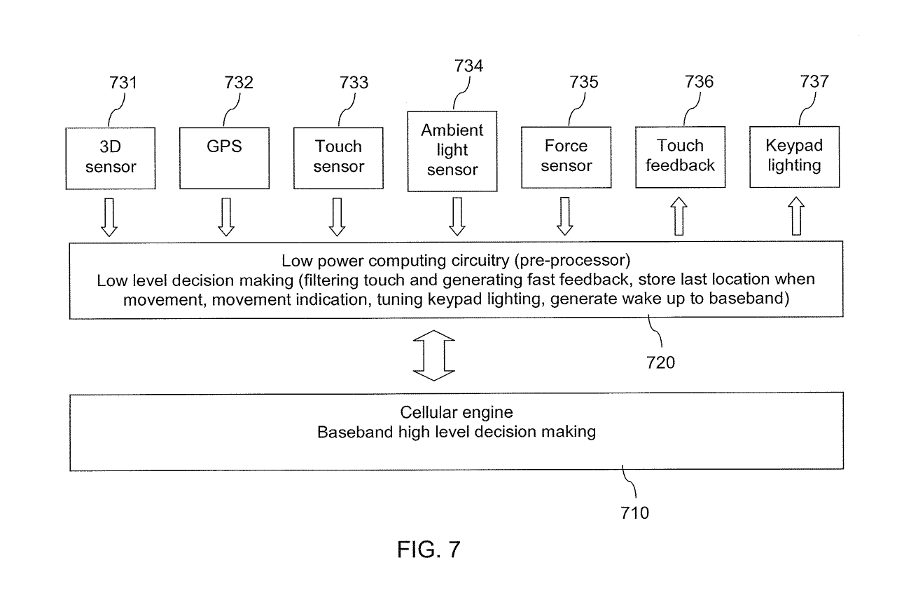

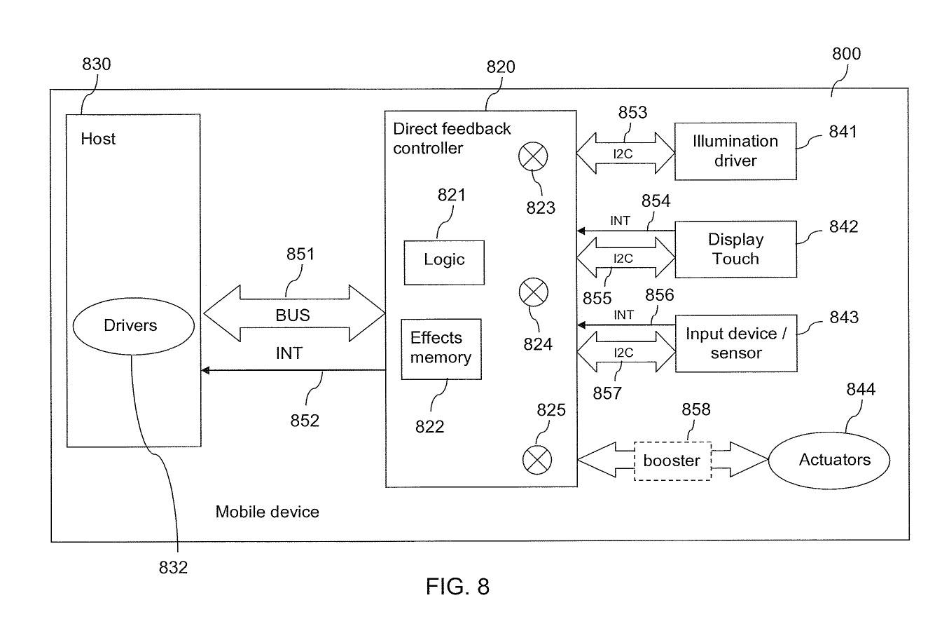

FIG. 7 is a schematic block diagram illustrating some further variation options for the embodiments presented with reference to FIGS. 1-6.

The blocks depicted in FIG. 7 represent components of a mobile phone. The components comprise a cellular engine 710 and a low power computing circuitry 720. They further comprise a plurality of components arranged to provide an input to the low power computing circuitry 720, including a three-dimensional (3D) motion sensor 731, for instance in the form of an accelerometer, a GPS receiver 732 as an exemplary satellite based navigation system receiver, a touch sensor 733, for example in the form of a touch screen or of touch buttons, an ambient light sensor 734, and a force sensor 735. There could be many additional or alternative input components, like a keypad, a fingerprint sensor, etc. The components of FIG. 7 further comprise a plurality of components suited to provide a feedback to a user and arranged to receive an output from the low power computing circuitry 720, including a touch or haptic feedback component 736, like a vibrator or material exhibiting a reverse piezoelectrical effect, and a keypad lighting 737. There could be many additional or alternative output components, like a display backlight, an adaptive decoration, loudspeakers, a main display, a secondary display, etc.

Cellular engine 710 takes care of the baseband high level decision making.

Low power computing circuitry 720 is implemented as a pre-processor for cellular engine 710. It could be a dedicated component; it could be an enhanced keypad controller similarly as in the embodiment of FIG. 3; or it could be integrated in some other processing component external to cellular engine 710 which has some spare processing power, like an illumination controller.

Low power computing circuitry 720 takes care of various kinds of low level decisions. It filters touch input by a user via touch input component 733 as well as gestures based on signals from the 3D sensor 731 and an applied force based on signals from force sensor 735, and generates a fast feedback via touch feedback component 736 and/or keypad lighting 737. It stores the latest location provided by GPS receiver 732, registers movements based on the input of 3D motion sensor 731 and stores a movement indication. It turns on the entire keypad lighting 737 when a key is pressed or a selective part of keypad lighting 737 to guide a user to a key that should be pressed next.

Low power computing circuitry 720 generates an interrupt request to wake up the baseband whenever some received input fulfils a criterion that has been defined for the current state of the device. States and criteria could be provided by cellular engine 710 to low power computing circuitry 720. They can be defines similarly as in the embodiments of FIGS. 1-6. An alternative or additional criterion for opening a key guard could be for instance a predefined touch gesture on touch sensor 733 or a gesture that is detected by 3D sensor 731, like a double tapping on the device in a certain direction. An additional state could be a location tracking state of the device. A criterion for such a location tracking state could be set such that only when 3D sensor 731 indicates a movement, low power computing circuitry 720 activates GPS receiver 732 and sends an interrupt request to cellular engine 710 so that cellular engine 710 is woken up to receive and process measurement results of GPS receiver 732.

When there has been no movement indicated by 3D sensor 731 for a while and ambient light sensor 734 indicates very low ambient light, low power computing circuitry 720 may assume a night state to be given during a certain basic state, e.g. during a key guard state, previously indicated by cellular engine 710 to low power computing circuitry 720. When a user sweeps over the device in a way that is registered by touch sensor 733, low power computing circuitry 720 may then illuminate a time information on the screen without any involvement of cellular engine 710.

Low power computing circuitry 720 is thus suited to decreases the number of baseband wake ups and to reduce the baseband computing in standby. Further, it may eliminate unnecessary GPS usage. Further, it may shorten the touch feedback time and control the keypad illumination.

FIG. 8 is a schematic block diagram of another exemplary embodiment of an apparatus according to the invention. In this embodiment, the apparatus is again a mobile device 800, for instance a personal digital assistant.

The mobile device 800 comprises inter alia a direct feedback controller 820, a host 830 and a plurality of user input and output components.

The user input and output components may comprise an illumination driver 841, which is responsible for a keypad illumination, a display backlight or any other kind of illumination at the device 800. It may be linked to direct feedback controller 820 via an I²C bus 853.

The user input and output components may comprise a touch sensitive display 842 that may be linked to direct feedback controller 820 via an interrupt line 854 and an I²C bus 855.

The user input and output components may further comprise some other input device and/or some sensor 843 that may be linked to direct feedback controller 820 via an interrupt line 856 and an I²C bus 857.

The user input and output components may also comprise an actuator 844 that may be linked to an actuator interface of the direct feedback controller 820 via a booster 858 arranged for actuating piezoelectric material of the actuator 844.

Host 830 comprises drivers 832, which support a control of user output components via direct feedback controller 820. It is to be understood that it may comprise in addition the components of the host 330 of FIG. 3. Host 830 may be linked to direct feedback controller 820 via an interrupt line 851 and a bus 852, for example an I²C bus.

Direct feedback controller 820 could be for example a generic input/output (GENIO) device.

Direct feedback controller 820 comprises a logic 821. Logic 821 is responsible for detecting a user input via one of components 842 and 843 and for generating a feedback when needed via one of components 841 and 844. In this scope, it also takes care of coordinating a feedback that is determined to be required by logic 821 itself and a feedback that is requested by host 830.

Logic 821 is also responsible for forwarding sensor data to drivers 832 of host 830. Logic 821 may be a programmable logic comprising registers.

Direct feedback controller 820 comprises in addition an effects memory 822. Effects memory 822 may store data for particular effects for a feedback to a user. The data may be downloaded from host 830 and may be accessed by logic 821 for controlling the feedback.

Direct feedback controller 820 comprises in addition a mixer 823. Mixer 823 mixes or prioritizes triggers for illumination synchronization from logic 821 and host 830 according to settings and policies under control of logic 821. The mixed triggers are provided to illumination driver 841 via bus 853 to cause a visible feedback to a user.

Direct feedback controller 820 comprises in addition a mixer 824. Mixer 824 receives and mixes or prioritizes triggers from touch sensitive display 842 and from sensor or user input device 843 according to settings and policies under control of logic 821. The triggers may be preprocessed similarly as described for the user input with reference to FIG. 3 to decide whether an interrupt request is to be sent by logic 821 to host 830 depending on a current state that has been indicated by host 830.

Direct feedback controller 820 comprises in addition a mixer 825. Similarly as mixer 823, mixer 825 mixes or prioritizes instructions for actuator 844 according to settings and policies under control of logic 821. The mixed instructions may be used for selecting an associated pulse width modulation (PWM) signal, which is then applied via booster 858 to actuator 844.

Bus 851 may be used by host 830 to enable or disable settings and policies in the direct feedback controller 820, to cause a download of effects to the effects memory 822, to cause a download of programmable logic to the registers of logic 821, to start or stop the execution of downloaded effects, to define a wave format driving for the actuator 844, etc.

It is to be understood that all possibilities of variation for interrupt line and bus mentioned with reference to the embodiment of FIG. 3 apply equally to all interrupt lines and busses of the embodiment of FIG. 8.

In a variation of the embodiment of FIG. 8, illumination driver 841 could be linked in addition directly to host 830 via an additional bus. In a further variation, components 842 and/or 843 could be linked in addition via interrupt line and/or bus to host 830.

As becomes apparent from the above description, the logic 821 may be configured to control and coordinate a feedback to a user as well as realize all functions of keypad controller 320 of FIG. 3. Alternatively, a first component may be provided for receiving the user input and sensor data and to generate an interrupt request to a host when required, and a second component may be provided for controlling a feedback to a user.

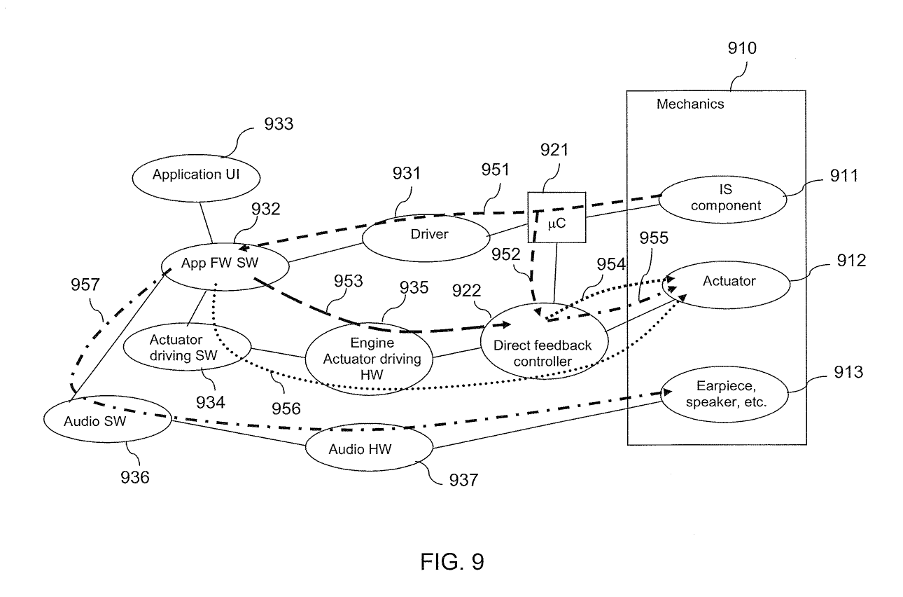

FIG. 9 is a diagram illustrating different feedback options in an embodiment of a device in which the latter approach is used.

User interface mechanics 910 of the device include a touch sensitive input solution (IS) component 911, which may comprise touch buttons or zoom stripes, etc. User interface mechanics 910 include moreover an actuator 912 for audio and tactile feedback, and earpiece and/or loudspeaker 913. User interface mechanics 910 may further comprise a component for optical feedback, for example illumination driver 841 of FIG. 8. The IS component 911 is linked to a microcontroller (μC) 921 operating as a first preprocessor. The microcontroller 921 is linked to a direct feedback controller 922 operating as a second preprocessor. The microcontroller 921 is further linked via an IS driver 931 to an application (app) framework (FW) software (SW) 932. Such an application FW SW may be for example a middleware that provides application programming interfaces (APIs) for applications, or it may be software providing a framework for developing applications on top of a middleware. The application FW SW 932 is further linked to an application user interface (UI) 933. The application FW SW 932 is further linked via an actuator driving SW 934, an engine actuator driving hardware (HW) 935 and the direct feedback controller 922 to the actuator 912 and/or the component for optical feedback. The application FW SW 932 is further linked directly to the engine actuator driving HW 935. The application FW SW 932 is further linked via an audio SW 936 and an audio HW 937 to the earpiece and/or loudspeaker 913. Components 931-937 belong to a main engine and the software is executed by a processor of this main engine.

A user input via touch sensitive IS component 911 is registered in preprocessor 921. Preprocessor 921 decides based on a current state indicated by the main engine whether an interrupt request to the main engine should be generated. If this is the case, the user input signal is forwarded after the interrupt request via driver 931 to application FW SW 932 (path 951). In addition, the input signal is forwarded in any case to direct feedback controller 922 (path 952).

The application FW SW 932 controls via the engine actuator driving HW the direct feedback controller 922 (path 953). That is, it enables and disables a direct feedback functionality of the direct feedback controller 922.

If a direct feedback is enabled, direct feedback controller 922 performs a feedback decision for selected cases and controls the actuator 912 accordingly. One example of a feedback is causing a vibration by means of actuator 912 (path 954) and/or causing the actuator to output a click-sound (path 955) to confirm to a user that an input via a touch button has been registered. Direct feedback controller 922 may also control a component for optical feedback, for example an illumination driver which controls e.g. the illumination of a display and/or a keypad.

If the user input does not cause preprocessor 921 to generate an interrupt request, the main engine may not be involved in the feedback. This may shorten the latency time for the feedback and save processing power at the main engine.

In case details of a user input reach application FW SW 932 after an interrupt request, the application FW SW 932 may perform a feedback decision as well.

In the case a haptic feedback is determined to be required, such a feedback may be caused via actuator driving SW 934, engine actuator driving HW 935, direct feedback controller 922 and actuator 912 (path 956). Direct feedback controller 922 takes care in this case of prioritizing direct and application based feedback via actuator 912 according to some predetermined rules. The predetermined rules may be implemented in a fixed manner in direct feedback controller 922 or be downloaded from application FW SW 932 depending on a current state.

In the case an audio feedback, like a key tone or a text to speech function, is determined to be required, such a feedback is caused by the application FW SW 932 via audio SW 936, audio HW 937 and earpiece or speaker 913 (path 957).

In a variation of the embodiment of FIG. 9, direct feedback controller 922 may be configured to take care of all feedback decisions for actuator 912. In this case, components 934 and 935 could be omitted. The application FW SW 933 may be configured also in this case to enable or disable the direct feedback.

It has to be noted that while IS component 911 and microcontroller 921 are depicted as separate entities in FIG. 9, they may optionally be implemented as two parts of a single IS device. IS component 911 could be a passive part and microcontroller 921 an active part of such an IS device. A resistive or capacitive touch sensor that is used as an IS device, for instance, may comprise a microcontroller part and sensor foils or layers. Moreover, instead of a touch sensitive input solution, another kind of input solution could be used as well. A similar separation between an active and a passive part as for resistive or capacitive touch sensors may be used for example for joysticks too. In the case of optical IS devices, like optical finger navigation devices or finger print sensors, there may be even only a single, integrated IS component without any separate components like foils. In the case that a key dome is to be used as an IS device, an input/output (IO) expander or keyboard controller may be seen as the microcontroller part and a dome switch matrix may be seen as the passive part of the IS device. In the case that a force sensor is to be used as an IS device, one or more sensors may produce an analog signal and a controller including some algorithm may provide and optionally calculate a digital output signal indicative of an applied force.

It has further to be noted that while microcontroller 921 has been described to operate as a first preprocessor, which decides whether an interrupt request to the main engine should be generated, the microcontroller 921 could also be a conventional microcontroller 921 of an IS device. In this case, an additional preprocessor may be provided between IS driver 931 and microcontroller 921. This preprocessor could be responsible for deciding whether there is a reason to interrupt the main engine. Alternatively, direct feedback controller 922 may be implemented to decide in addition based on a user input and a current state whether an interrupt request to the main engine should be generated. To this end, an additional enable/disable control line may be provided from direct feedback controller 922 to microcontroller 921. Direct feedback controller 922 may then use this control line to allow microcontroller 921 to interrupt the host or not.

The preprocessor(s) used in any of the above described embodiments could also be used for additional operations that are conventionally handled by the host. It may be used for example as a sensor preprocessor, which takes care of executing some frequently run algorithms that are usually executed by a host processor. Again, this may allow saving energy at the host. An example of such a frequently run algorithm is a step counting algorithm of a pedometer algorithm. For a pedometer algorithm, new measurements of an accelerometer may have to be received at approximately 40 Hz. The preprocessor may include the entire pedometer algorithm to perform a step counting based on the accelerometer measurements using step counting registers. Alternatively, the preprocessor may have a buffer memory storing the measurements of the accelerometer. The host could then read several stored measurements results at a time, thus reducing the number of engine interrupts and the engine wake time.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)

(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory, a random access memory, a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The functions illustrated by the processor 110 in combination with the memory 120 or the processor 321 in combination with the memory 322 or the low power computing circuitry 720 can be viewed as means for receiving an indication of a current state from a processor, as means for detecting a user input, as means for determining whether the user input matches a criterion that is defined for the current state, and as means for generating an interrupt request to the processor if it is determined that the user input matches the criterion defined for the current state.

The program codes in memory 120 or memory 322 can also be viewed as comprising such means in the form of functional modules.

It will be understood that all presented embodiments are only exemplary, that features of these embodiments may be omitted or replaced and that other features may be added. Any mentioned element and any mentioned method step can be used in any combination with all other mentioned elements and all other mentioned method step, respectively. It is the intention, therefore, to be limited only as indicated by the scope of the claims appended hereto.

1.-39. (canceled)

40. A method comprising:
receiving by an apparatus an indication of a current state from a processor;
detecting by the apparatus a user input;
determining by the apparatus whether the user input matches a criterion that is defined for the current state; and
generating by the apparatus an interrupt request to the processor if it is determined that the user input matches the criterion defined for the current state.

41. The method according to claim 40, further comprising receiving by the apparatus from the processor for at least one state information about at least one criterion defined for the at least one state.

42. The method according to claim 40, wherein the criterion comprises at least one of:
an activation of a predetermined key;
an activation of a predetermined key at least for a predetermined time;
an activation of a predetermined combination of keys;
an activation of a predetermined combination of keys within a predetermined time span;
a stroke on a touch sensitive user interface; and
an application of a predetermined force.

43. The method according to claim 40, further comprising causing by the apparatus a feedback to a user, wherein causing the feedback is independent from a participation of the processor from which the indication of the current state is received.

44. The method according to claim 43, wherein causing the feedback comprises causing a notification of a user if it is determined that the user input does not match at least one criterion defined for the current state.

45. The method according to claim 40, further comprising causing by the apparatus a feedback to a user, wherein causing the feedback comprises causing an indication to a user, which further user input has to be carried out to ensure that the user input matches the entire criterion, if it is determined that the user input matches a part of a criterion defined for the current state.

46. The method according to claim 40, further comprising coordinating by the apparatus feedback to a user which is caused by the processor from which the indication of the current state is received and feedback to a user which is caused independently from a participation of the processor from which the indication of the current state is received.

47. The method according to claim 40, wherein the current state is one of a plurality of predetermined states comprising at least one locked state.

48. An apparatus comprising at least one processor and at least one memory including computer program code, the at least one memory and the computer program code configured to cause the at least one processor at least to perform:
receive an indication of a current state from another processor;
detect a user input;
determine whether the user input matches a criterion that is defined for the current state; and
generate an interrupt request to the other processor if it is determined that the user input matches the criterion defined for the current state.

49. The apparatus according to claim 48, wherein the at least one memory and the computer program code are configured to cause the at least one processor to receive from the other processor for at least one state information about at least one criterion defined for the at least one state.

50. The apparatus according to claim 48, wherein the criterion comprises at least one of:
an activation of a predetermined key;
an activation of a predetermined key at least for a predetermined time;
an activation of a predetermined combination of keys;
an activation of a predetermined combination of keys within a predetermined time span;
a stroke on a touch sensitive user interface;
an application of a predetermined force.

51. The apparatus according to claim 48, wherein the at least one memory and the computer program code are configured to cause the at least one processor to cause a feedback to a user, wherein causing the feedback is independent from a participation of the other processor from which the indication of the current state is received.

52. The apparatus according to claim 51, wherein the at least one memory and the computer program code are configured to cause the at least one processor to cause as the feedback to a user a notification of the user if it is determined that the user input does not match at least one criterion defined for the current state.

53. The apparatus according to claim 51, wherein the at least one memory and the computer program code are configured to cause the at least one processor to cause a feedback to a user, to cause as the feedback to a user, if it is determined that the user input matches a part of a criterion defined for the current state, an indication to a user, which further user input has to be carried out to ensure that the user input matches the entire criterion.

54. The apparatus according to claim 48, wherein the at least one memory and the computer program code are configured to cause the at least one processor to coordinate feedback to a user which is caused by the other processor from which the indication of the current state is received and feedback to a user which is caused independently from a participation of the other processor from which the indication of the current state is received.

55. The apparatus according to claim 48, wherein the current state is one of a plurality of predetermined states including at least one locked state.

56. The apparatus according to claim 48, wherein the apparatus further comprises at least one of:
a keypad;
a touch sensitive user interface;
a three-dimensional motion sensor;
an accelerometer;
a satellite based navigation system receiver;
an ambient light sensor;
a force sensor;
a lighting circuitry;
an adaptive decoration; and
a haptic feedback component.

57. The apparatus according to claim 48, wherein the apparatus further comprises the other processor and at least one other memory including other computer program code, the at least one other memory and the other computer program code configured to cause the other processor at least to generate and provide an indication of a current state upon a respective change of state.

58. The apparatus according to claim 48, wherein the apparatus is one of:
a chip;
a keyboard controller; and
a mobile communication device.

59. A computer program code causing a processor to realize the following when executed by the processor:
receiving an indication of a current state from another processor;
detecting a user input;
determining whether the user input matches a criterion that is defined for the current state; and
generating an interrupt request to the other processor if it is determined that the user input matches the criterion defined for the current state.
